(19) United States
(12) Patent Application Publication
(10) Pub. No.: US 2016/0154566 A1
(43) Pub. Date: Jun. 2, 2016

(54) ADAPTIVE RUNNING MODE

(71) Applicant: SONY CORPORATION, Tokyo (JP)

(72) Inventors: Milan Rakic, Lund (SE); Richard Bunk, Lund (SE)

(21) Appl. No.: 14/354,433

(22) PCT Filed: Aug. 22, 2013
(86) PCT No.: PCT/IB13/56816

§ 371 Date: Apr. 25, 2014

(51) Int. Cl. G06F 3/0484; G06F 3/0488

(52) U.S. Cl. CPC G06F 3/04842; G06F 3/0488

(57) ABSTRACT

The invention is directed to systems, methods and computer program products for enabling a user to control a mobile device when the user is in motion. The invention could also be used for “visibility assistance,” either for vision-impaired users, or simply to visualize screen objects obscured by the finger or other pointing device. An exemplary method comprises: determining a location of contact on a mobile device display, wherein the display presents at least one option; determining an option located near the location of contact; magnifying the first option on the display such that the first option encloses the location of contact; and initiating execution of a function associated with the first option.

### BACKGROUND

A user of a mobile device (e.g., a music player, a mobile phone, a watch, etc.) may wish to use the device (e.g., interact with the mobile device user interface) when running or exercising. For example, the user may interact with the user interface in order to play a song, change a song, check email, etc. However, when the user is in motion, the user may find it difficult to interact with the small user interface of a mobile device. For example, when the user is attempting to touch or select a first option on the user interface, the user may actually end up touching or selecting a second option, which may be near the first option, on the user interface. Therefore, there is a need to enable a user to control or interact with a mobile device when the user is in motion.

### BRIEF SUMMARY

Embodiments of the invention are directed to systems, methods and computer program products for enabling a user to control a mobile device when the user is in motion. An exemplary method comprises: determining a location of contact on a mobile device display, wherein the display presents at least one option; determining a first option located near the location of contact; magnifying the first option on the display such that the first option encloses the location of contact; and initiating execution of a function associated with the first option.

In some embodiments, the first option is at least one of the most logical option or the option nearest to the location of contact.

In some embodiments, magnifying the first option comprises increasing the dimensions of the first option.

In some embodiments, the magnified first option is highlighted or is presented in a different color from the first option.

In some embodiments, the magnified first option encloses the first option.

In some embodiments, an outline of the first option is visible inside the magnified first option.

In some embodiments, the contact is made using either a finger or an object.

In some embodiments, the mobile device comprises at least one of a mobile phone, a watch, a music player, a camera, or a tablet computing device.

In some embodiments, the contact is maintained for a predetermined period.

In some embodiments, determining a first option located near the location of contact comprises determining the first option is selectable.

In some embodiments, the location of contact is within an area of the first option.

In some embodiments, the location of contact is determined based on where the contact is released from the display, and the location of contact is not determined based on where the contact is initially detected on the display.

In some embodiments, the location of contact is determined based on where the contact is initially detected on the display, and the location of contact is not determined on where the contact is released from the display.

In some embodiments, the contact is determined based on a camera or a sensor associated the display.

In some embodiments, the method further comprises providing tactile or audio feedback to a user of the mobile device.

In some embodiments, an intermediary logic layer is provided between an existing application that is executed on the mobile device and sensor or camera logic input for determining the location of contact.

In some embodiments, the method further comprises enabling an adaptive running mode when the mobile device determines that the mobile device or the user is in motion.

In some embodiments, the contact comprises actual contact or virtual contact.

In some embodiments, virtual contact occurs when a user's finger or object hovers above the display.

In some embodiments, an apparatus is provided for enabling a user to control a mobile device when the user is in motion. The apparatus comprises a display configured to present at least one option; a memory; a processor; and a module stored in the memory, executable by the processor, and configured to: determine a location of contact on the display; determine a first option located near the location of contact; magnify the first option on the display such that the first option encloses the location of contact; and initiate execution of a function associated with the first option.

In some embodiments, a computer program product is provided enabling a user to control a mobile device when the user is in motion. The computer program product comprises a non-transitory computer-readable medium comprising a set of codes for causing a computer to: determine a location of contact on the display; determine a first option located near the location of contact; magnify the first option on the display such that the first option encloses the location of contact; and initiate execution of a function associated with the first option.

In some embodiments, another method, apparatus, and computer program product are provided. The method comprises identifying an initial contact on a mobile device display; determining that the initial contact is dragged across the display while maintaining contact on the display; determining that the initial contact is released from the display; determining a location associated with the initial contact first contacting the display or associated with the initial contact being released from the display; determining an option located near the location; and initiating execution of a function associated with the option. An apparatus and computer program product may be provided to execute this method.

In some embodiments, the method further comprises presenting a graphical lasso from the location to the determined option.

In some embodiments, the initial contact is associated with a first location on the display, and the release of the contact is associated with a second location on the display, and the method further comprises highlighting or magnifying a first option located near the first location when the initial contact is detected.

In some embodiments, when the release of the contact is detected, the method further comprises highlighting or magnifying a second option located near the second location, and restoring the first option to its original magnification or highlighting.

In some embodiments, while the initial contact is being dragged across the display, the method further comprises progressively restoring the first option to its original magnification or highlighting, and progressively increasing the magnification or highlighting of the second option.

In some embodiments, another method, apparatus, and computer program product are provided. The method comprises determining a location of actual or predicted contact on a mobile device display, wherein the display presents at least one option; determining information presented in an area enclosing the location; highlighting or magnifying the information; and presenting the highlighted or magnified information to the user. An apparatus and computer program product may be provided to execute this method.

### BRIEF DESCRIPTION OF THE DRAWINGS

Having thus described embodiments of the invention in general terms, reference will now be made to the accompanying drawings, where:

FIG. 1 is an exemplary process flow for enabling a user to control a mobile device when the user is in motion, in accordance with embodiments of the present invention;

FIG. 2 is an exemplary user interface for enabling a user to control a mobile device when the user is in motion, in accordance with embodiments of the present invention;

FIG. 3 is an exemplary mobile device, in accordance with embodiments of the present invention;

FIG. 4 is a diagram illustrating a rear view of exemplary external components of the mobile device depicted in FIG. 3, in accordance with embodiments of the present invention; and

FIG. 5 is a diagram illustrating exemplary internal components of the mobile device depicted in FIG. 3, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for enabling a user to control a mobile device when the user is in motion (e.g., when the user is running, exercising, etc.). The present invention does not compensate for shifts in a mobile device display interface based on accelerometer input. Instead, the present invention directly interacts with a user via a dynamic display interface as described below.

A user may establish initial contact (e.g., a user's finger or other object) with a display, drag the contact location on the display, and then release contact from the display. In some embodiments, an option on the mobile device display is selected upon detecting the release of the contact from the display and not upon detecting initial contact on the display. In such embodiments, when the user drags the user's finger or other object on the display, the selected option may not be the option associated with the initial contact on the display. Instead, the selected option may be the option associated with the final contact on the display before releasing the contact from the display. In alternate embodiments, the selected option may be the option associated with the initial contact on the display, and may not be the option associated with the final contact on the display. In still other embodiments, the selected option may be an option located on the path between the initial contact and the final contact locations.

If the contact location is determined to be located on top of an option, the mobile device determines that the option has been selected and initiates a function associated with the option. If the contact location is not determined to be located on top of any option on the display, the mobile device determines the option located nearest to the contact location. In some embodiments, if the contact location is not determined to be located on top of any option on the display (and is near one or more options), the mobile device determines the “best logical” option rather than the “nearest” contact location. For example, the “best logical” option may be based on the user's prior contact point (or the previous determined option) or may be based on the user's contact history over a predetermined period. For example, if the user is watching a video on the mobile device display, and the user's contact point is between the “play” and “pause” options (but closer to the “play” option), the mobile device will determine that the “best logical” option is the “pause” option, and not the “play” option since a video is currently being played on the mobile device display. Therefore, in some embodiments, the best logical option is not the option nearest to the contact location.

The mobile device subsequently magnifies the determined option so that the option area encloses the contact location and encloses the original option. Alternatively, the determined option may not be graphically magnified. Instead, the determined option may be highlighted (e.g., change in color, change in font, etc.). Alternatively or additionally, a graphical “lasso” or “rubber band” may be displayed from the contact point to the determined option. The “lasso” encloses the contact point and the determined option. Still alternatively, the determined option may be stretched in a “lasso” or “rubber band” fashion from its position on the display to the contact point. This provides visual feedback to the user indicating the option selected by the user. Additionally, the color of the magnified, highlighted, or stretched area may be different from the color of the original option area. However, an outline of the original option area may still be visible inside the magnified, highlighted, or stretched area. Additionally, the mobile device may provide tactile feedback to the user such that the user feels that the option magnetically snaps to the location of the user's contact. As used herein, magnification may additionally or alternatively refer to highlighting (with or without an increase in dimensions) or stretching an option on the display.

In some embodiments, the option is not magnified if the user's contact location falls on top of an option. In such embodiments, the option is magnified if the user's contact location does not fall on top of any option on the display. In alternate embodiments, the option is magnified regardless of whether or not the user's contact location falls on top an option. In some embodiments, the contact has to be maintained for a period equal to or greater than a predetermined period in order for the mobile device to magnify the option. The period may be computed based on one or more of a period of initial contact, a period of final contact prior to release, and a period of drag between the initial contact and the final contact. As used herein, an option may comprise a selectable option (e.g., information which when selected by the user links the user to more information).

Additionally, in some embodiments, a display may include an integrated camera and/or a sensor. The camera and/or sensor may be located under, above, or on substantially the same surface level as the display. This functionality enables the mobile device to see (using the camera) or sense (using the sensor) where the user's finger or other object touches the display or hovers over the display (e.g., in the air) within a predetermined distance from the surface of the display. Information received from the camera and/or sensor may be used to determine the location (e.g., x, y, and z coordinates) of the finger or object with respect to the display (or a point on the display). This location may be referred to as the control location. The area surrounding the control location, if the finger is touching the display, or under the control location, if the finger is hovering above the display, may be highlighted so that the user can receive visual feedback of the location of contact either before contact is made with the display (predicted or virtual contact) or during contact (actual contact) made with the display. The highlighted area may be presented in a different color compared to the rest of the display. Additionally or alternatively, the mobile device may provide tactile feedback at the location of actual or virtual contact. Additionally or alternatively, the mobile device may provide other feedback signals (e.g., an audio signal) upon detection of contact, detection of contact release, or at any point in time between the detection of contact and the detection of contact release.

Additionally or alternatively, a magnification window may be presented on or above the control location on the display and the information in the control location (and/or the information located above, below, or on either side of the control location) may be presented in the magnification window. As described herein, the magnification window may be presented in conjunction with a magnetic snapping mechanism. When the user moves the user's finger or other object on the display or above the display, the control location, and consequently the magnification window, also moves. The magnification window may be highlighted or presented in a different color and may overlap any information located under the magnification window. Additionally, tactile feedback may be provided to the user as the user moves the control location. As used herein, a magnification window may also be referred to as a magnifying glass. The present invention is not limited to presenting the magnification window for magnifying a cursor position associated with text input. Instead, the magnification window may be provided for any pre-existing mobile device applications.

The various features of the invention described herein may be enabled by using an intermediary logic layer between an application that is being executed on the mobile device and sensor or camera logic input that determines an actual or virtual contact location. This enables the present invention to be utilized with existing mobile applications without modification.

The various features of the invention may be executed by the mobile device when the mobile device is in an adaptive running mode. This mode is enabled when the mobile device determines that the user is in motion. The mobile device may determine that the user is in motion using a sensor (e.g., a gyroscope) that detects shaking of the mobile device (e.g., shaking with a speed greater than or equal to a predetermined speed). Alternatively, a user may manually enable the adaptive running mode. Still alternatively, the adaptive running mode may be triggered upon detection of a “long-press” event (e.g., when a user maintains contact with the display for equal to or greater than a predetermined period). Additionally, the adaptive running mode may be disengaged when the “long-press” event ends.

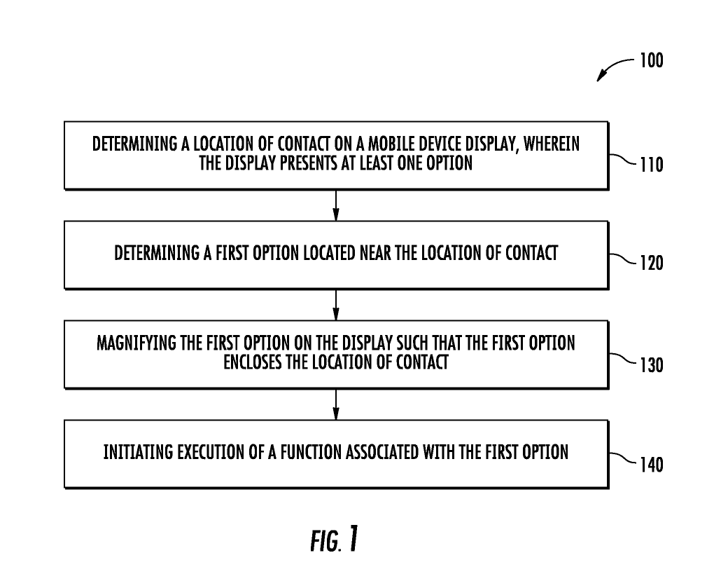

Referring now to FIG. 1, FIG. 1 presents a process flow 100 for enabling a user to control a mobile device when the user is in motion. The various process blocks presented in FIG. 1 may be executed in an order that is different from that presented in FIG. 1. At block 110, the process flow comprises determining a location of contact on a mobile device display, wherein the display presents at least one option. At block 120, the process flow comprises determining a first option located near the location of contact. At block 130, the process flow comprises magnifying the first option on the display such that the first option encloses the location of contact. At block 140, the process flow comprises initiating execution of a function associated with the first option. As used herein, contact on the display may refer to a tap (e.g., single or multiple tap) or a push (e.g., single push or multiple pushes) on the display.

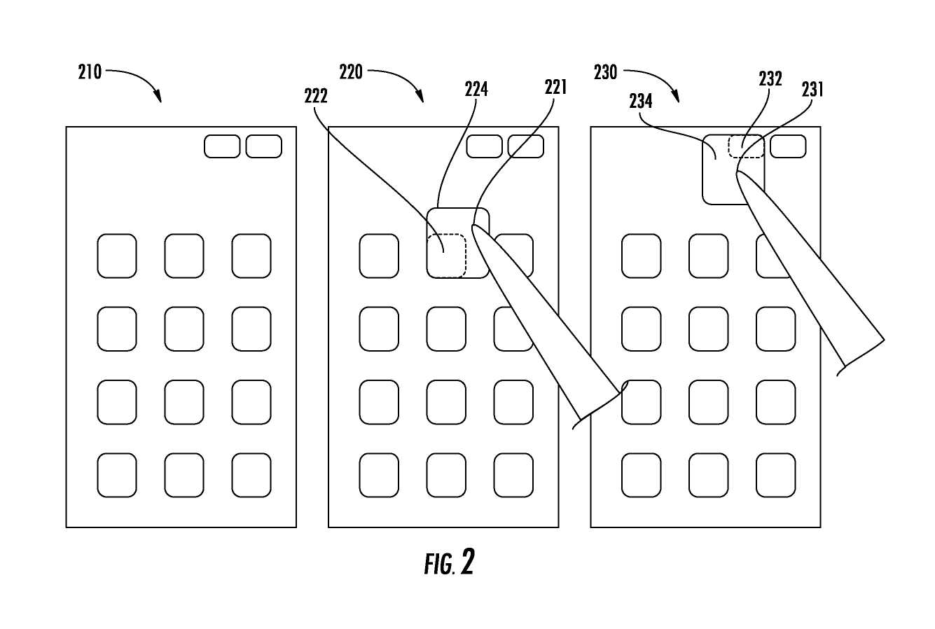

Referring now to FIG. 2, FIG. 2 presents an exemplary interface 210 associated with a mobile device display. The interface 210 comprises several selectable options. As indicated in interfaces 220 and 230, the user attempts to select options 222 and 232. However, the user's contact locations are 221 and 231. The mobile device determines that the options located nearest to contact locations 221 and 231 are options 222 and 232. Consequently, the mobile device magnifies these options. The magnified options 224 and 234 are also presented in FIG. 2. These magnified options provide the user with visual feedback of the user's selection. Additionally, the magnified options may snap (e.g., magnetically snap) to the user's contact locations so that the user receives tactile feedback of the user's selection.

Another interpretation of the interfaces in FIG. 2 is also possible. When the user's contact location 221 is determined by the mobile device, the mobile device also determines that the nearest or most logical option is option 222. Therefore, option 222 is presented as a magnified option 224. When the contact point is lifted from the display, the magnified option 224 may be reduced to its original size. Alternatively, the user may move the contact point from contact point 221 to contact point 231 while maintaining contact with the display. During this movement, when the contact point is determined to be closer to option 232 rather than option 222, the magnified option 224 is reduced to its original size, while the option 232 is presented as a magnified option 234. Still alternatively, if the contact point, while maintaining contact with the display, moves from contact point 221 towards contact point 231, the magnified option 224 progressively decreases to its original size 222. As the contact point approaches contact point 231, the option 232 is progressively magnified 234. Although FIG. 2 indicates an option being magnified, in other embodiments, the option may be highlighted (with or without changing the dimensions of the option) or stretched.

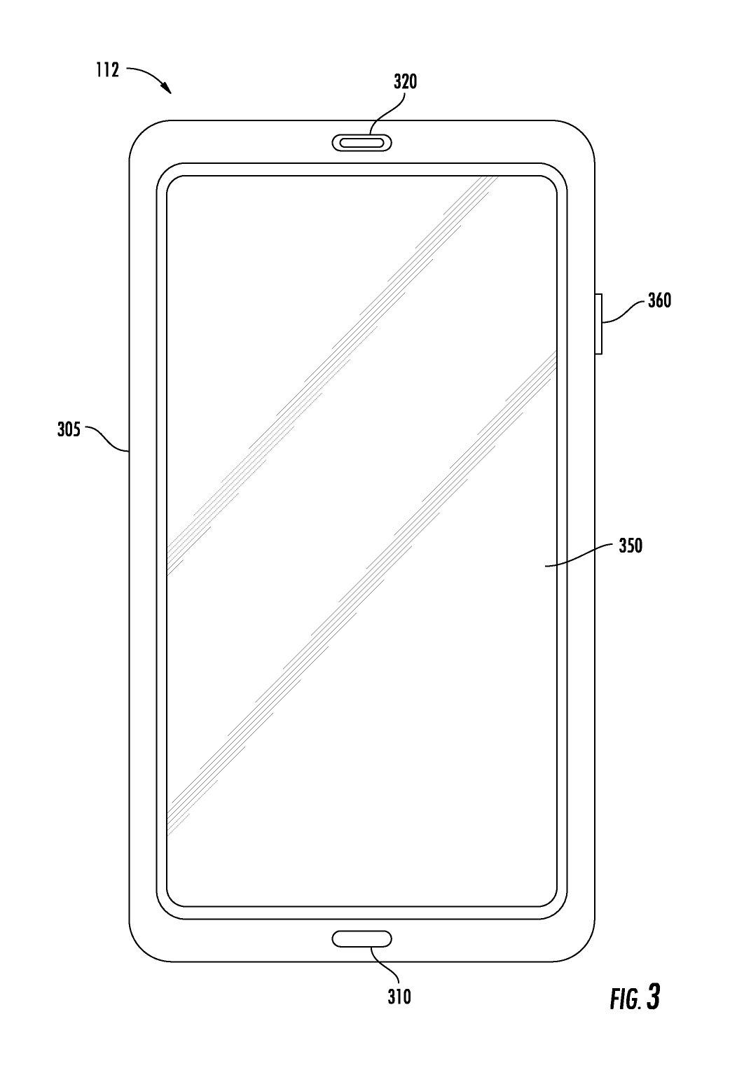

Referring now to FIG. 3, FIG. 3 is a diagram illustrating a front view of external components of an exemplary mobile device. The mobile device illustrated in FIG. 3 is a mobile communication device (e.g., portable mobile communication device such as a mobile phone). In alternate embodiments, the mobile device may be any other computing device such as a tablet computing device, a laptop computer, a watch, a music player, or the like, wherein the mobile device may or may not provide communication capability. The mobile device may perform any of the computing functions described herein.

Housing 305 may include a structure configured to contain or at least partially contain components of mobile device 112. For example, housing 305 may be formed from plastic, metal or other natural or synthetic materials or combination(s) of materials and may be configured to support microphone 310, speaker 320, display 350, and camera button 360.

Microphone 310 may include any component capable of transducing air pressure waves to a corresponding electrical signal. For example, a user may speak into microphone 310 during a telephone call. Speaker 320 may include any component capable of transducing an electrical signal to a corresponding sound wave. For example, a user may listen to music through speaker 320.

The display 350 may function as a touchpad or touchscreen. Touchpad may include any component capable of providing input to device 112. Touchpad may include a standard telephone keypad or a QWERTY keypad. Touchpad may also include one or more special purpose keys. A user may utilize touchpad for entering information, such as text or a phone number, or activating a special function, such as placing a telephone call, playing various media, capturing a photo, setting various camera features (e.g., focus, zoom, etc.) or accessing an application.

Display 350 may include any component capable of providing visual information. For example, in one implementation, display 350 may be a liquid crystal display (LCD). In another implementation, display 350 may be any one of other display technologies, such as a plasma display panel (PDP), a field emission display (FED), a thin film transistor (TFT) display, etc. Display 350 may be utilized to display, for example, text, image, and/or video information. Display 350 may also operate as a view finder, as will be described later. A camera button 360 may also be provided that enables a user to take an image. However, in alternate embodiments, the camera button 360 may not be provided.

Since mobile device 112 illustrated in FIG. 3 is exemplary in nature, mobile device 112 is intended to be broadly interpreted to include any type of electronic device that includes an image-capturing component. For example, mobile device 112 may include a mobile phone, a personal digital assistant (PDA), a portable computer, a camera, or a watch. In other instances, mobile device 112 may include, for example, security devices or military devices. Accordingly, although FIG. 3 illustrates exemplary external components of mobile device 112, in other implementations, mobile device 112 may contain fewer, different, or additional external components than the external components depicted in FIG. 3. Additionally, or alternatively, one or more external components of mobile device 112 may include the capabilities of one or more other external components of mobile device 112. For example, display 350 may be an input component (e.g., a touchscreen such as a capacitive touchscreen). The touchscreen may function as a keypad or a touchpad. Additionally or alternatively, the external components may be arranged differently than the external components depicted in FIG. 3.

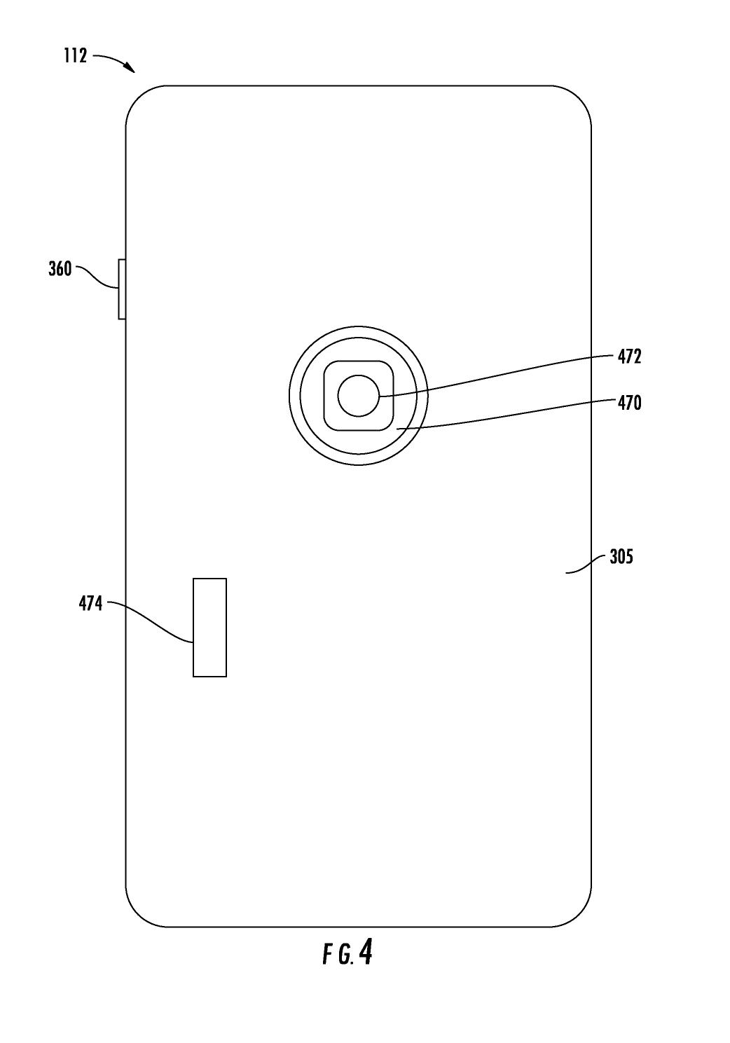

Referring now to FIG. 4, FIG. 4 is a diagram illustrating a rear view of external components of the exemplary mobile device. As illustrated, in addition to the components previously described, mobile device 112 may include a camera 470, a lens assembly 472, a proximity sensor 476, and a flash 474.

Camera 470 may include any component capable of capturing an image. Camera 470 may be a digital camera. Display 350 may operate as a view finder when a user of mobile device 112 operates camera 470. Camera 470 may provide for adjustment of a camera setting. In one implementation, mobile device 112 may include camera software that is displayable on display 350 to allow a user to adjust a camera setting.

Lens assembly 472 may include any component capable of manipulating light so that an image may be captured. Lens assembly 472 may include a number of optical lens elements. The optical lens elements may be of different shapes (e.g., convex, biconvex, plano-convex, concave, etc.) and different distances of separation. An optical lens element may be made from glass, plastic (e.g., acrylic), or plexiglass. The optical lens may be multicoated (e.g., an antireflection coating or an ultraviolet (UV) coating) to minimize unwanted effects, such as lens flare and inaccurate color. In one implementation, lens assembly 472 may be permanently fixed to camera 470. In other implementations, lens assembly 472 may be interchangeable with other lenses having different optical characteristics. Lens assembly 472 may provide for a variable aperture size (e.g., adjustable f-number).

Proximity sensor 476 (not shown in FIG. 4) may include any component capable of collecting and providing distance information that may be used to enable camera 470 to capture an image properly. For example, proximity sensor 476 may include a proximity sensor that allows camera 470 to compute the distance to an object. In another implementation, proximity sensor 476 may include an acoustic proximity sensor. The acoustic proximity sensor may include a timing circuit to measure echo return of ultrasonic soundwaves. In embodiments that include a proximity sensor 476, the proximity sensor may be used to determine a distance to one or more moving objects, which may or may not be in focus, either prior to, during, or after capturing of an image frame of a scene. In some embodiments, proximity of an object to the mobile device may be calculated during a post-processing step (e.g., after capturing the image). In still other embodiments, the proximity sensor 476 may determine that a finger or object is located close to the display, and information provided by the proximity sensor 476 may be used to determine a control location on the display under the finger or object, wherein the finger or object is not touching the display.

Flash 474 may include any type of light-emitting component to provide illumination when camera 470 captures an image. For example, flash 474 may be a light-emitting diode (LED) flash (e.g., white LED) or a xenon flash. In another implementation, flash 474 may include a flash module.

Although FIG. 4 illustrates exemplary external components, in other implementations, mobile device 112 may include fewer, additional, and/or different components than the exemplary external components depicted in FIG. 4. For example, in other implementations, camera 470 may be a film camera. Additionally, or alternatively, depending on mobile device 112, flash 474 may be a portable flashgun. Additionally, or alternatively, mobile device 112 may be a single-lens reflex camera. In still other implementations, one or more external components of mobile device 112 may be arranged differently.

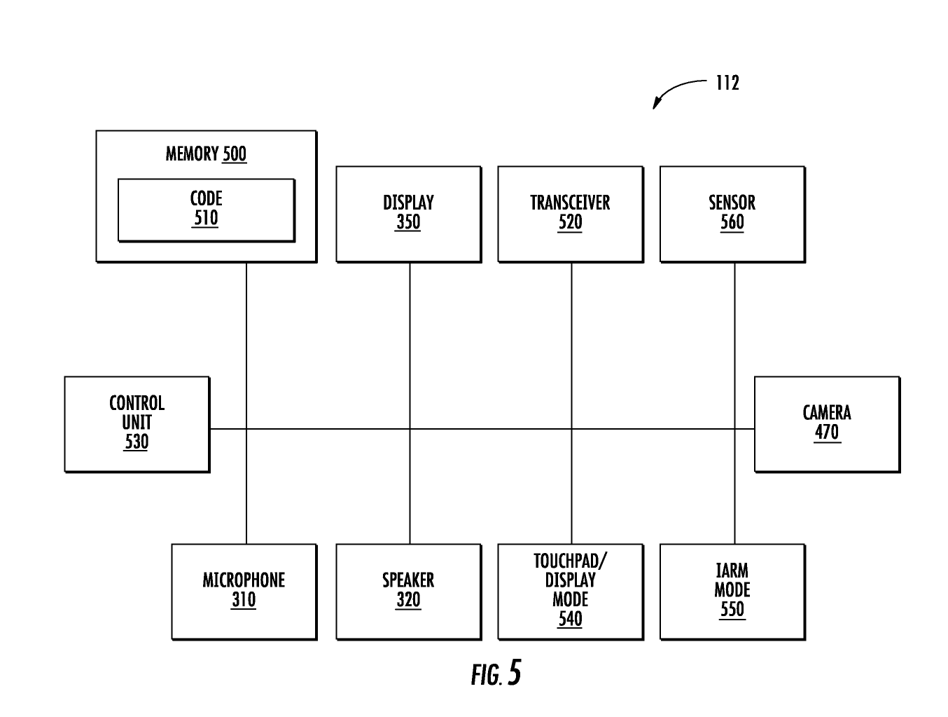

Referring now to FIG. 5, FIG. 5 is a diagram illustrating internal components of the exemplary mobile device. As illustrated, mobile device 112 may include microphone 310, speaker 320, display 350, camera 470, a memory 500, a transceiver 520, and a control unit 530. Additionally, the control unit 530 may enable a user to switch between touchpad or display mode 540. In touchpad mode, the display 350 functions as at least one of an input device (e.g., a numeric keypad or a QWERTY touchpad) or an output device. In display mode, the display 350 functions as an output device. Additionally, the control unit 530 enables triggering an adaptive running mode (IARM) 550 as described herein. The camera 470 and the sensor 560 may be used to perform various process associated with the IARM mode as described herein.

The mobile device 112 may also include a near-field communication (NFC) chip. The chip may be an active or passive chip that enables data to be transmitted from the mobile device 112 to a receiving terminal (or received at the mobile device 112 from a sending terminal). An active chip is activated using a power source located in the mobile device 112. A passive chip is activated using an electromagnetic field of the receiving terminal.

Memory 500 may include any type of storing component to store data and instructions related to the operation and use of mobile device 112. For example, memory 500 may include a memory component, such as a random access memory (RAM), a read only memory (ROM), and/or a programmable read only memory (PROM). Additionally, memory 500 may include a storage component, such as a magnetic storage component (e.g., a hard drive) or other type of computer-readable or computer-executable medium. Memory 500 may also include an external storing component, such as a Universal Serial Bus (USB) memory stick, a digital camera memory card, and/or a Subscriber Identity Module (SIM) card.

Memory 500 may include a code component 510 that includes computer-readable or computer-executable instructions to perform one or more functions. These functions include initiating and/or executing the processes described herein. The code component 510 may work in conjunction with one or more other hardware or software components associated with the mobile device 112 to initiate and/or execute the processes described herein. Additionally, code component 510 may include computer-readable or computer-executable instructions to provide other functionality other than as described herein.

Transceiver 520 may include any component capable of transmitting and receiving information wirelessly or via a wired connection. For example, transceiver 520 may include a radio circuit that provides wireless communication with a network or another device.

Control unit 530 may include any logic that may interpret and execute instructions, and may control the overall operation of mobile device 112. Logic, as used herein, may include hardware, software, and/or a combination of hardware and software. Control unit 530 may include, for example, a general-purpose processor, a microprocessor, a data processor, a co-processor, and/or a network processor. Control unit 530 may access instructions from memory 500, from other components of mobile device 112, and/or from a source external to mobile device 112 (e.g., a network or another device).

Control unit 530 may provide for different operational modes associated with mobile device 112. Additionally, control unit 530 may operate in multiple modes simultaneously. For example, control unit 530 may operate in a camera mode, a music player mode, and/or a telephone mode. For example, when in camera mode, face-detection and tracking logic may enable mobile device 112 to detect and track multiple objects (e.g., the presence and position of each object's face) within an image to be captured.

Although FIG. 5 illustrates exemplary internal components, in other implementations, mobile device 112 may include fewer, additional, and/or different components than the exemplary internal components depicted in FIG. 5. For example, in one implementation, mobile device 112 may not include transceiver 520. In still other implementations, one or more internal components of mobile device 112 may include the capabilities of one or more other components of mobile device 112. For example, transceiver 520 and/or control unit 530 may include their own on-board memory.

The various features described with respect to any embodiments described herein are applicable to any of the other embodiments described herein.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A method for enabling a user to control a mobile device when the user is in motion, the method comprising:
determining a location of contact on a mobile device display, wherein the display presents at least one option;
determining a first option near the location of contact;
magnifying the first option on the display such that the first option encloses the location of contact; and
initiating execution of a function associated with the first option.

2. The method of claim 1, wherein the first option is at least one of the most logical option or the option nearest to the location of contact.

3. The method of claim 1, wherein magnifying the first option comprises increasing the dimensions of the first option.

4. The method of claim 1, wherein the magnified first option is highlighted or is presented in a different color from the first option.

5. The method of claim 1, wherein the magnified first option encloses the first option.

6. The method of claim 1, wherein an outline of the first option is visible inside the magnified first option.

7. The method of claim 1, wherein the contact is made using either a finger or an object.

8. The method of claim 1, wherein the mobile device comprises at least one of a mobile phone, a watch, a music player, a camera, or a tablet computing device.

9. The method of claim 1, wherein the contact is maintained for a predetermined period.

10. The method of claim 1, wherein determining a first option located near the location of contact comprises determining the first option is selectable.

11. The method of claim 1, wherein the location of contact is within an area of the first option.

12. The method of claim 1, wherein the location of contact is determined based on where the contact is released from the display, and wherein the location of contact is not determined based on where the contact is initially detected on the display.

13. The method of claim 1, wherein the location of contact is determined based on where the contact is initially detected on the display, and wherein the location of contact is not determined on where the contact is released from the display.

14. The method of claim 1, wherein the contact is determined based on a camera or a sensor associated the display.

15. The method of claim 1, further comprising providing tactile or audio feedback to a user of the mobile device.

16. The method of claim 1, wherein an intermediary logic layer is provided between an existing application that is executed on the mobile device and sensor or camera logic input for determining the location of contact.

17. The method of claim 1, further comprising enabling an adaptive running mode when the mobile device determines that the mobile device or the user is in motion.

18. The method of claim 1, wherein the contact comprises actual contact or virtual contact.

19. (canceled)

20. (canceled)

21. (canceled)

22. (canceled)

23. (canceled)

24. (canceled)

25. An apparatus for enabling a user to control a mobile device when the user is in motion, the system comprising:
a memory;
a processor;
a module, stored in the memory, executable by the processor, and configured to:
determine a location of contact on a mobile device display, wherein the display presents at least one option;
determine a first option near the location of contact;
magnify the first option on the display such that the first option encloses the location of contact; and
initiate execution of a function associated with the first option.

26. A computer program product for enabling a user to control a mobile device when the user is in motion, the computer program product comprising a non-transitory computer-readable medium comprising a set of codes for causing a computer to:
determine a location of contact on a mobile device display, wherein the display presents at least one option;
determine a first option near the location of contact;
magnify the first option on the display such that the first option encloses the location of contact; and
initiate execution of a function associated with the first option.
